(19) United States
(12) Patent Application Publication
(10) Pub. No.: US 2006/0070093 A1
(43) Pub. Date: Mar. 30, 2006

(54) Combination candle centerpiece and side loading music CD player

(76) Inventor: Joy Mangano, St. James, NY (US)

Correspondence Address: Galgano & Burke;Suite 35, 300 Rabro Drive, Hauppauge, NY, 11788, US

(21) Appl. No.: 10/954,829

(22) Filed: Sep. 30, 2004

(51) Int. Cl. G11B 33/02; G11B 17/03; G11B 17/04

(52) U.S. Cl. 720/646; 720/653

(57) ABSTRACT

A compact decorative centerpiece has an upper recess dimensioned to accept a standard three inch diameter pillar candle, the decorative centerpiece concealing a battery powered music CD player. In order to provide access to the CD player without removing the candle, a unique side hinged arrangement allows the CD player to partially slide out of the side of the centerpiece. The speaker(s) of the CD player is (are) mounted in the centerpiece facing down from the bottom and small legs are provided to make space between the speaker(s) and the table. The top of the centerpiece is covered with a removable metallic dish having a decorative perimeter and a recess for receiving a standard pillar candle.

### BACKGROUND OF THE INVENTION

1. Field of the Invention

This invention relates broadly to candle holders, decorative centerpieces, and to music CD players. More particularly, this invention relates to a combination candle centerpiece and side loading music CD player.

2. State of the Art

Holidays and other special events are often celebrated with music and sometimes with candles and/or decorative table centerpieces. The idea of combining music and candles has been disclosed in U.S. patents dating back somewhat more than a decade. For example, U.S. Pat. No. 4,983,119, issued Jan. 8, 1991 to Lin discloses a “Musical Candle Actuated by a Thermistor Switch.” The candle includes a longitudinal thermistor strip embedded proximate to the candle wick and coupled to a musical integrated circuit (IC) in a base supporting the candle. The thermistor senses when the candle is burning, actuates the integrated circuit when the candle is burning, and stops the music when the candle is extinguished. The Lin device, though interesting, has several disadvantages. The candle is not replaceable. Once the candle is consumed, the device is useless. The musical selection is not alterable and is not of very high quality being an electronic simulation of music.

More recently, U.S. Pat. No. 6,033,209 issued Mar. 7, 2000 to Shin et al. discloses a “Melody Candle Assembly”. This device is similar to the Lin device having a musical IC in a base upon which a candle is mounted and a sensor for activating the IC only when the candle is burning. The main difference is that Shin et al. use an optical fiber rather than a thermistor to sense when the candle is lit and that two selectable melodies are provided in the IC. Nevertheless, the candle is not replaceable. Here too, once the candle consumed, the device is useless. The musical selection is limited and is not of very high quality being an electronic simulation of music.

U.S. Pat. No. 6,050,812 issued Apr. 18, 2000 to Chuang discloses a “Candleholder Set with Musical Function”. The Chuang device is a candle holder have a musical IC mounted in it and a centrally located optical sensor upon which a specially constructed candle is placed. The candle has a central core of clear wax surrounded by opaque wax. The candle is placed with the clear wax core aligned above the optical sensor. Theoretically, when the candle is burning, light is transmitted through the clear wax core to be detected by the sensor which activates the IC. Although the Chuang device provides the possibility of replacing the candle, it is a non-standard candle and may be difficult to obtain. Moreover, the device suffers from the same limited musical selection and bad sound quality that the other devices suffer from.

The state of the art musical candle holders all have very limited musical selections, bad sound quality, require non-standard candles or have non-replaceable candles and are not particularly attractive.

### SUMMARY OF THE INVENTION

It is therefore an object of the invention to provide a musical candle holder.

It is another object of the invention to provide a musical candle holder which accepts standard replaceable candles which are easy to obtain.

It is a further object of the invention to provide a musical candle holder which has the ability to play a very large number of musical selections.

It is also an object of the invention to provide a musical candle holder which has relatively high quality sound.

It is an additional object of the invention to provide a musical candle holder which also functions as a decorative centerpiece.

In accord with these objects, which will be discussed in detail below, the musical candle holder of the present invention includes a compact decorative centerpiece with an upper recess dimensioned to accept a standard three inch diameter pillar candle, the decorative centerpiece concealing a battery powered music CD player. In order to provide access to the CD player without removing the candle, a unique side hinged arrangement allows the CD player to partially slide out of the side of the centerpiece. The speaker(s) of the CD player is (are) mounted in the centerpiece facing down from the bottom and small legs are provided to make space between the speaker(s) and the table. The top of the centerpiece is covered with a removable metallic dish having a decorative perimeter and a recess for receiving a standard pillar candle. The metallic plate protects the otherwise plastic structure from the heat of the candle and dripping wax. Moreover, the plate, being removable, is easily cleaned. Because the music generating device is a CD player, the sound quality is much better than the prior art devices and the number of musical selections is virtually limitless. Thus, the appropriate musical selection for every holiday and special event is readily available for use with the centerpiece. The decorative removable candle supporting plate may be provided with decoration which is indicative of a particular holiday or special event and thus, several interchangeable plates may be provided to be selected from for particular holidays or events. For example, a Christmas plate may be decorated with holly, an Easter plate decorated with bunnies and eggs, an Independence Day plate decorated with red, white and blue bunting, etc.

Certain of the foregoing and related objects are also achieved in a musical candle centerpiece for use with a standard size candle comprising: a generally cylindrical structure; a side loading music CD player mounted within said generally cylindrical structure; and a removable plate mounted on top of said cylindrical structure, said removable plate containing a recess dimensioned to receive a bottom portion of the candle.

Preferably, said removable plate has decorative indicia surrounding the recess, said removable plate is metallic and said generally cylindrical structure is substantially plastic. Desirably, the centerpiece further comprises a plurality of supporting feet upon which said generally cylindrical structure is mounted, and a loudspeaker coupled to said CD player and mounted in said generally cylindrical structure facing down. Advantageously, said side loading music CD player includes a hinged door which swings out from the side of said generally cylindrical structure, said removable plate includes an outer metallic decorative ring and an inner metallic candle tray, and said side loading music CD player is a top loading CD player which is hingedly coupled to said cylindrical structure so as to open from the side.

In a preferred embodiment of the invention the musical candle centerpiece for use with a standard size candle, comprises: a generally cylindrical structure; a music CD player mount4ed within said generally cylindrical structure; and a removable metallic plate mounted on top of said cylindrical structure, said removable plate containing a recess dimensioned to receive a bottom portion of the candle. Most desirably, said metallic plate includes an inner candle tray and an outer decorative ring and said outer decorative ring includes indicia associated with a holiday or special event, and an additional outer decorative ring having indicia associated with a different holiday or special event is also included.

In a particular preferred embodiment of the invention, a musical candle centerpiece for use with a candle, comprises: a generally disk-shaped structure; a side loading music CD player mounted within said generally disk-shaped structure; and a plate mounted on top of said disk-shaped dimensioned to receive and support a candle. Most advantageously, said plate is removable and is supported in the central recess of a decorative ring, and said removable plate is metallic and said generally cylindrical, disk-shaped structure is substantially plastic. Most desirably, said side loading music CD player includes a hinged door which swings out from the side of said generally cylindrical structure and said side loading music CD player is a top loading CD layer which is hingedly coupled to said cylindrical structure so as to open from the side.

Additional objects and advantages of the invention will become apparent to those skilled in the art upon reference to the detailed description taken in conjunction with the provided figures.

### BRIEF DESCRIPTION OF THE DRAWINGS

FIG. 1 is a perspective view of candle centerpiece according to the invention together with a partially burned candle;

FIG. 2 is a view similar to FIG. 1 but without the candle;

FIG. 3 is an exploded perspective view of the candle centerpiece illustrating the removable candle tray and decorative ring;

FIG. 4 is a perspective view illustrating the CD player in a partially opened state;

FIG. 5 is a perspective view showing the CD player in a fully opened position sufficient to allow the (re)placement of a CD disk; and

FIG. 6 is a bottom plan view illustrating the location of a speaker and battery compartment.

### DETAILED DESCRIPTION OF THE PREFERRED EMBODIMENTS

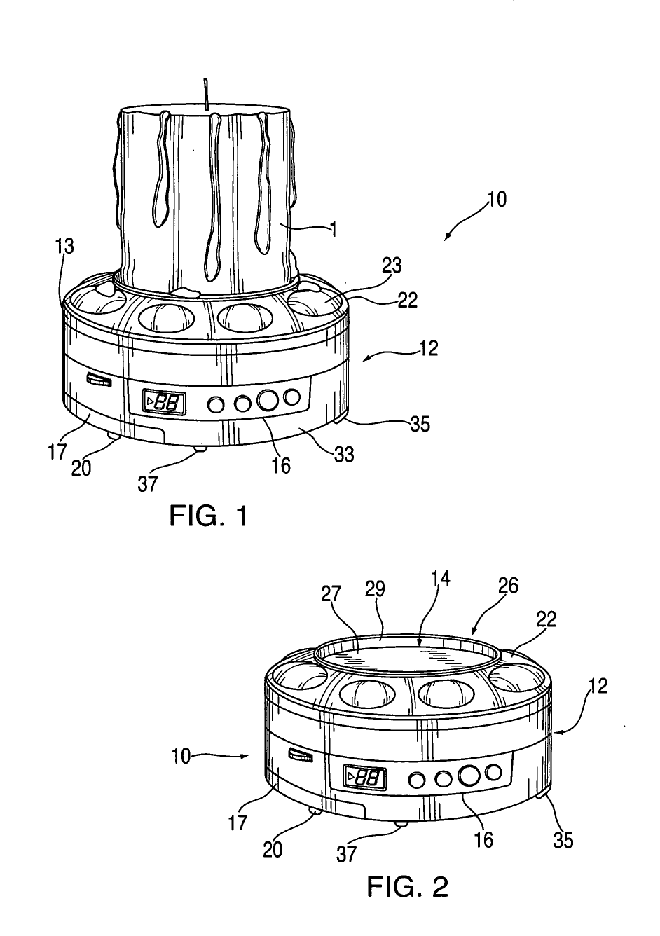

Turning now to FIGS. 1-3, the musical candle holder 10 of the present invention includes a disc-shaped, preferably cylindrical compact, decorative centerpiece 12 with an upper recess 14 dimensioned to accept, e.g., a standard three inch diameter pillar candle 1, the decorative centerpiece concealing a battery powered music CD player 16. In order to provide access to the CD player 16 without removing the candle 1, a unique side-hinged arrangement allows the top-loading CD player 16 to pivot and partially slide out of the side of the centerpiece 12.

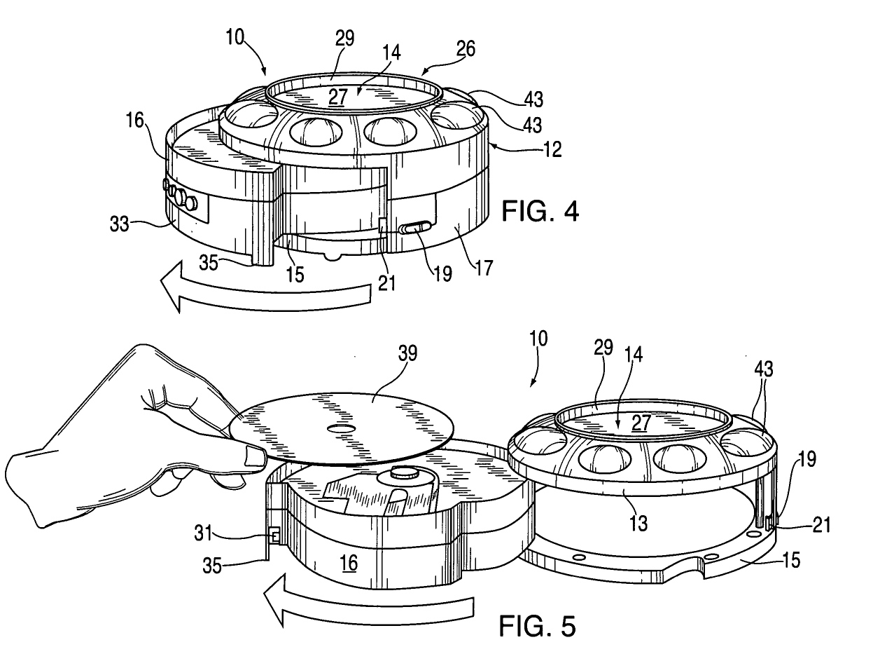

More particularly, as seen best in FIGS. 4 and 5, the generally disc shaped CD player 16 is pivotally hinged at one end between the top wall 13 and bottom annular frame 15 of centerpiece 12 so that it is movable in a pivotal manner between a fully closed position and a fully opened position (compare FIGS. 2, 4 and 5). The sidewall 17 of centerpiece 12 is provided with a spring-loaded switch 19 connected to an L-shaped tab 21 which, in turn, is normally releasably secured to catch 31. When switch 19 is pushed to the right (FIG. 4), tab 21 is moved to a position releasing catch 31, thereby permitting the CD player 16 to open in the direction of the arrow in FIG. 4 until it reaches its fully open position as shown in FIG. 5. In this position, the user can insert and/or remove a CD 39 into, or from, the CD player 16, respectively.

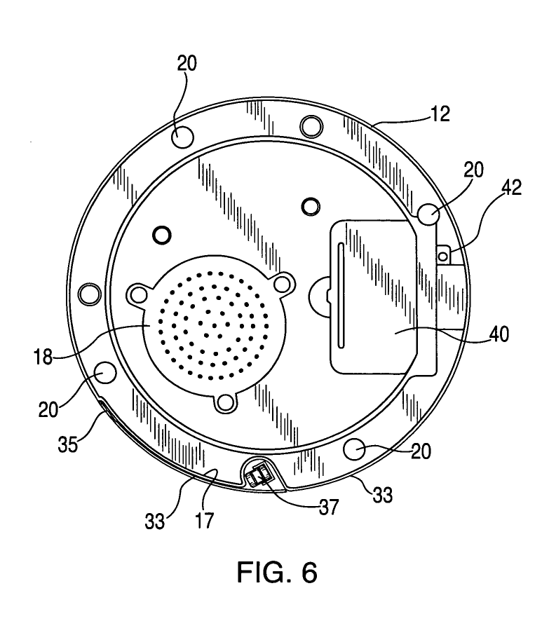

Preferably, the CD player 16 has a spring-loaded hinge (not shown) biasing the CD player toward its open position so that the CD player will automatically move to its open position upon operation of switch 19. To assist this automatic operation, the CD player 16 is provided with a downwardly depending foot 35 (FIG. 4) and a roller 37 (FIG. 6) which maintains the CD player in a horizontal level position as it assists it as it slides into its open position.

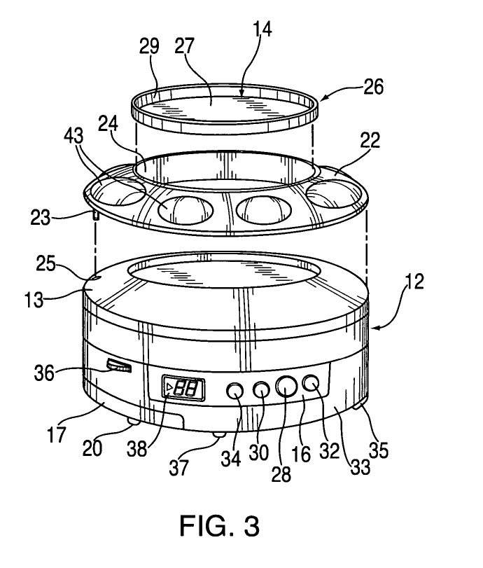

As seen best in FIG. 3, the top wall 13 of the centerpiece 12 is covered with a removable, annular plastic ring 22 having a decorative perimeter and a central recess 24 for receiving a metallic candle dish 26. The decorative plastic ring 22 has a locking pin 23 which engages a hole 25 in the top wall 13 of the centerpiece 12 to secure the ring 22 to the centerpiece 12.

The dish 26 has a central, recessed planar surface 27 surrounded by a raised circular rim 29 which cooperate to define recess 14 and is dimensioned to receive the base of, e.g., a standard cylindrical, pillar candle. The metallic dish 26 protects the otherwise plastic structure from the heat of the candle and dripping wax as illustrated in FIG. 1. Moreover, the ring 22 and dish 26, being removable, are easily cleaned. Because the music generating device is a CD player 16, the sound quality is much better than the prior art devices and the number of musical selections is virtually limitless. Thus, the appropriate musical selection for every holiday and special event is readily available for use with the combination centerpiece and CD holder 10.

The decorative removable candle ring 22 may be provided with decoration which is indicative of a particular holiday or special event and thus, several interchangeable rings may be provided to be selected from for particular holidays or events. For example, an Easter ring decorated with eggs 43, a Christmas ring may be decorated with holly (not shown), an Independence Day ring decorated with red, white and blue bunting, (not shown) etc.

The music CD player 16 includes conventional controls including a PLAY/PAUSE button 28, a STOP button 30, a FAST FORWARD (track forward) button 32, and a REWIND (track backward) button 34. A “short press” of the forward and back buttons moves from track to track. A long press fast forwards or backwards within the playing selection. A volume control wheel 36 and a track number display 38 are also provided.

As shown best in FIG. 6, in the closed position, the sidewall 33 of the CD player lies flush with the remaining peripheral edge of the sidewall 17 of centerpiece 12 (sidewall 17 being recessed in the area between foot 35 and roller 37). Power is provided by two AA batteries located in a battery compartment 40 in the base. An optional AC adapter jack 42 may also be provided. The speaker(s) 18 of the CD player is (are) mounted in the centerpiece facing down from the bottom and small legs or feet 20 are provided to provide an air space between the speaker(s) and the table or other supporting surface (not shown).

There have been described and illustrated herein a combination candle centerpiece and side loading CD player. While particular embodiments of the invention have been described, it is not intended that the invention be limited thereto, as it is intended that the invention be as broad in scope as the art will allow and that the specification be read likewise.

For example, while the ring 22 and dish 26 are shown as two separate pieces, they could be a single piece in the form of a plate. In addition, they could be permanently affixed to the centerpiece, although such would prevent the change of the decorative perimeter of ring 22. In addition, although the side-mounted CD player is preferably hinged in a spring-loaded manner to the centerpiece to permit it to partially slide out to permit insertion and removal of CD's, other side-mounted arrangements may be used, such as the CD players typically used in computers and other electronic components which have an electrically powered, automatically operable slide-out CD tray, although the same is more expensive and due to its flat face, may destroy the cylindrical symmetry of the dish-shaped centerpiece and the “hidden” quality of the CD player. Of course, this may not be a problem if other shapes of the dish-shaped centerpiece are chosen (e.g., square or rectangular). In certain applications, the CD player may also include a radio.

It will therefore be appreciated by those skilled in the art that yet other modifications could be made to the provided invention without deviating from its spirit and scope as claimed.

What is claimed is:

1. A musical candle centerpiece for use with a standard size candle, said centerpiece comprising:
a generally cylindrical structure;
a side loading music CD player mounted within said generally cylindrical structure; and
a removable plate mounted on top of said cylindrical structure, said removable plate containing a recess dimensioned to receive a bottom portion of the candle.

2. The centerpiece according to claim 1, wherein:
said removable plate has decorative indicia surrounding the recess.

3. The centerpiece according to claim 1, wherein:
said removable plate is metallic and said generally cylindrical structure is substantially plastic.

4. The centerpiece according to claim 1, further comprising:
a plurality of supporting feet upon which said generally cylindrical structure is mounted.

5. The centerpiece according to claim 4, further comprising:
a loudspeaker coupled to said CD player and mounted in said generally cylindrical structure facing down.

6. The centerpiece according to claim 1, wherein:
said side loading music CD player includes a hinged door which swings out from the side of said generally cylindrical structure.

7. The centerpiece according to claim 1, wherein:
said removable plate includes an outer metallic decorative ring and an inner metallic candle tray.

8. The centerpiece according to claim 1, wherein:
said side loading music CD player is a top loading CD player which is hingedly coupled to said cylindrical structure so as to open from the side.

9. A musical candle centerpiece for use with a standard size candle, said centerpiece comprising:
a generally cylindrical structure;
a music CD player mounted within said generally cylindrical structure; and
a removable metallic plate mounted on top of said cylindrical structure, said removable plate containing a recess dimensioned to receive a bottom portion of the candle.

10. The centerpiece according to claim 9, wherein:
said metallic plate includes an inner candle tray and an outer decorative ring.

11. The centerpiece according to claim 10, wherein:
said outer decorative ring includes indicia associated with a holiday or special event.

12. The centerpiece according to claim 11, further comprising:
an additional outer decorative ring having indicia associated with a different holiday or special event.

13. A musical candle centerpiece for use with a candle, said centerpiece comprising:
a generally disk-shaped structure;
a side loading music CD player mounted within said generally disk-shaped structure; and
a plate mounted on top of said disk-shaped structure dimensioned to receive and support a candle.

14. The centerpiece according to claim 13, wherein said disk-shaped structure is generally cylindrical.

15. The centerpiece according to claim 13, wherein:
said plate is removable and is supported in the central recess of a decorative ring.

16. The centerpiece according to claim 14, wherein:
said removable plate is metallic and said generally cylindrical, disk-shaped structure is substantially plastic.

17. The centerpiece according to claim 14, further comprising:
a plurality of supporting feet upon which said generally cylindrical structure is mounted.

18. The centerpiece according to claim 14, further comprising:
a loudspeaker coupled to said CD player and mounted in said generally cylindrical structure facing down.

19. The centerpiece according to claim 14, wherein:
said side loading music CD player includes a hinged door which swings out from the side of said generally cylindrical structure.

20. The centerpiece according to claim 13, wherein:
said side loading music CD player is a top loading CD player which is hingedly coupled to said cylindrical structure so as to open from the side.

21. The centerpiece according to claim 15, wherein:
said outer decorative ring includes indicia associated with a holiday or special event.
